(19) United States
(12) Patent Application Publication
(10) Pub. No.: US 2018/0373211 A1
(43) Pub. Date: Dec. 27, 2018

(54) Temperature Monitoring Device for Tool Spindles of Woodworking Machines, Preferably Moulding Machines, Woodworking Machines with such a Temperature Monitoring Device, and Method Using a Temperature Monitoring Device

(71) Applicant: Michael Weinig AG, Tauberbischofsheim (DE)

(72) Inventors: Albrecht Dawidziak, Großrinderfeld (DE); Hubert Klein, Wertheim-Nassig (DE)

(21) Appl. No.: 15/984,323

(22) Filed: May 19, 2018

(30) Foreign Application Priority Data
May 20, 2017 (DE) 10 2017 005 068.6

(51) Int. Cl. G05B 19/048; B27C 3/02; B27G 21/00

(52) U.S. Cl. CPC G05B 19/048; B27G 21/00; B27C 3/02

(57) ABSTRACT

A temperature monitoring device for tool spindles of woodworking machines such as moulding machines, with a spindle housing in which a spindle shaft with at least one rotary bearing is supported, has at least one temperature sensor for detecting the temperature of the rotary bearing of the spindle. Signals are supplied to at least one evaluation unit which converts the signals to temperature values. The temperature values are stored in at least one cloud from where the data by an app located on a smart device and/or by a browser can be retrieved.

### BACKGROUND OF THE INVENTION

The invention concerns a temperature monitoring device for tool spindles of woodworking machines, preferably moulding machines, according to the preamble of claim 1, a woodworking machine according to claim 13, as well as a method according to claim 16. In woodworking machines, in particular moulding machines, tools spindles are employed with which tools required for machining are rotatably driven. The tool spindles have a spindle shaft rotatably supported in a spindle housing. During woodworking, the rotary bearings which support the spindle shaft in the spindle housing are partially exposed to very high forces. This can lead to the rotary bearings being damaged. When a damaged rotary bearing is not recognized, this leads to failure of the corresponding tool spindle, which requires longer downtime of the machine as well as high repair costs. Possibly, surrounding parts within the machine are also impaired by a damaged rotary bearing, possibly even damaged.

It is therefore known (JP H8-1606 A) to monitor the temperature of the tool spindle with a temperature sensor. The temperature signals are supplied to an evaluation unit that generates a warning signal when the measured temperature reaches or surpasses a limit value. The warning signal is displayed on a screen. In addition, an acoustic signal is generated. When no operator is at the machine who can see and/or hear the warning message, the machine will continue to operate so that there is the risk that the tool spindle as well as additional machine parts become damaged.

The invention has the object to configure the temperature monitoring device of the aforementioned kind, the woodworking machine, and the method in such a way that an impending failure of the tool spindle in the woodworking machine can be recognized location-independent.

### SUMMARY OF THE INVENTION

This object is solved for the temperature monitoring device of the aforementioned kind in accordance with the invention with the characterizing features of claim 1, for the woodworking machine with the features of claim 13, and for the method with the features of claim 16.

In the temperature monitoring device, the temperature values detected by the evaluation unit are stored in the cloud. The data can be retrieved by means of the app located on the smart device and/or also by means of a browser by authorized persons. In this way, there is the possibility of being able to retrieve and view the data location-independent at any time. In this way, the customer and/or the manufacturer of the woodworking machine has the possibility of retrieving and checking the status of the monitored tool spindle at any time from the cloud. In this way, it is ensured that, upon reaching the temperature limit value, action can be taken timely in order to prevent failure of the tool spindle without a service technician having to be at the site of the machine, for example.

Advantageously, the temperature limit values can also be stored in the cloud.

Advantageously, the evaluation unit and the control unit for the machine containing the tool spindle are connected to each other by a common network (data network) so that a simple access to the evaluation unit as well as to the control unit is possible.

The control unit is advantageously embodied such that it transmits data sets to the cloud.

In a preferred embodiment, the control unit transmits data sets to the cloud at preset time intervals or when exceedance of a temperature limit value occurs. The data sets contain at least specifications in regard to the temperature at the spindle measured at the time of query.

The data sets can contain further specifications such as the environmental temperature and status data of the machine, whether and at which rotary speed the spindle is running, whether feed is running, whether wood is in the machine, which tools are mounted, and the like.

In an advantageous embodiment, the temperature limit values of the respective spindle are also contained in the stored data sets. The temperature limit values are advantageously transmitted to the cloud only at each switch-on action of the woodworking machine, preferably together with specifications in regard to the machine configuration, i.e., how many spindles are present at which positions, and supplemented to the data sets.

The data set which is represented in the app when retrieved contains advantageously data in regard to the number of warnings and the number of switch-off events of the machine, in relation to one spindle, respectively. In this way, the operator of the machine and/or an off-site service technician immediately obtains an indication to check the tool spindle which has caused the notification.

The data set which is created due to exceedance of a limit temperature is advantageously stored in an additional file.

In order for the user to receive a notification immediately, it is advantageous when the notification which is sent by the cloud is sent by push service to the smart device. The notification can be sent by e-mail or SMS to the smart device. Advantageously, the user of the smart device can select in the app the form in which he will receive the notification.

It is advantageous, when the data and/or the notifications are transmitted only to users of the app lodged as authorized persons, or can only be retrieved by these users. In this way, it is ensured that not anyone by means of the app has access to these data or notifications. The app on the smart device can be configured such that submenus can be accessed that contain detail information.

Moreover, it is possible that the user triggers a reset, for example, when he has checked the warning message. With this reset, the data in the data set or the data set itself is not deleted. The reset has the effect that the indicated number of warning and switch-off messages is reset, i.e., set to zero, and is not again displayed upon renewed retrieval, for example, due to a subsequent warning message.

The temperature sensor can be arranged in the spindle housing adjacent to the rotary bearing. In this way, it is possible to position the temperature sensor very close to the rotary bearing to be monitored. In this context, the spacing between the temperature sensor and the rotary bearing to be monitored can be very minimal so that the temperature of the rotary bearing can be detected properly.

In an advantageous embodiment, the spindle housing is provided with at least one axial bore which opens at an end face of the spindle housing and serves for receiving the temperature sensor. The temperature sensor can be pushed from the end face of the spindle housing very easily into the axial bore to a point where the sensor head or temperature detector of the sensor is positioned adjacent to the rotary bearing. The axial extension of the bore in the spindle housing has the advantage that adjustment movements of the spindle axle, in particular of the spindle housing, in axial direction as well as transverse thereto are not impaired when the sensor signals are transmitted through conduits. Within the bore the sensor is accommodated in a protected manner and does not interfere upon adjustment of the tool spindle.

In another advantageous embodiment, the spindle housing has at least one approximately radially extending bore which opens at the exterior of the spindle housing. Such a bore can be provided in a simple way at the spindle housing. When the temperature sensor is provided with a sensor conduit, it can be guided to the exterior along the shortest path.

A particularly advantageous embodiment results when the temperature sensor is arranged directly at or in the rotary bearing, preferably at or in the outermost stationary bearing ring. In this case, the temperature of the rotary bearing is detected with high precision.

When the tool spindle has a plurality of rotary bearings, for example, two rotary bearings, each one of the rotary bearings is then advantageously provided with at least one temperature sensor, respectively. When it is however known, for example, that only one of a plurality of rotary bearings has temperature problems, then it is sufficient to monitor only this one rotary bearing by means of at least one temperature sensor.

The signals of the temperature sensor can be transmitted either by means of at least one sensor conduit or wireless. The wireless transmission of the sensor signals has the advantage that laying of sensor conduits in the tool spindle and optionally further conduction to the evaluation unit within the woodworking machine is obsolete.

The signals of the temperature sensors can also be transmitted to a control unit of a moulding machine.

In the woodworking machine according to the invention, at least one of the tool spindles is embodied in the described inventive manner. Advantageously, all tool spindles of the woodworking machine are furnished with at least one temperature sensor with which the temperature of the rotary bearing of this tool spindle can be detected. The user of the woodworking machine can thus reliably retrieve the data of all tool spindles of the woodworking machine so that he is notified early on when one or several of the tool spindles are on the verge of failing.

Since the temperature of the rotary bearing can be affected by the environmental temperature of the tool spindle, the woodworking machine according to the invention advantageously has at least one additional sensor which determines the inner temperature of the woodworking machine, i.e., the environmental temperature of the tool spindle in the woodworking machine.

In a preferred embodiment, the signals of this additional temperature sensor are used for compensation of the temperature limit value of the rotary bearing. For example, when the environmental temperature in the woodworking machine rises, the rotary bearing will also heat up without this being caused by an excessive load on the rotary bearing. Accordingly, taking into account the measured environmental temperature, the temperature limit value is correspondingly raised so that the effect of the environmental temperature on the temperature of the rotary bearing is compensated. The compensation can also be performed directly at the temperature signals of the individual sensors.

In the method according to the invention, the temperature of the rotary bearing is continuously detected by the at least one temperature sensor and supplied to the evaluation unit. The data gathered by the evaluation unit are stored in the cloud. The data can be retrieved in processed form by means of an app located on a smart device and/or by means of a browser.

The signal generated by the evaluation unit can trigger a warning signal that indicates to the user that the monitored tool spindle has reached a critical range. The warning signal can be an acoustic and/or optical signal or, for example, a warning message on a screen and the like.

The evaluation unit can be part of the machine control unit. Advantageously, the evaluation unit is a unit which is separate from the machine control unit. In this case, the machine control unit retrieves the data or values from the evaluation unit. In case of a temperature exceedance detected by the evaluation unit, the machine control unit will be prompted to generate a warning message.

The signal generated by the evaluation unit can also trigger a switch-off signal by means of which machine functions, such as spindle, feed, are switched off. In this way, overloading and thus damage of the tool spindle are reliably prevented. Advantageously, all spindles and the feed of the woodworking machine are automatically switched off on the basis of the evaluated temperature signals.

It is advantageous when two differently high temperature limit values are monitored by the evaluation unit. When for the first time the lower temperature limit value is reached, then the evaluation unit advantageously can trigger a warning signal. Upon reaching the higher temperature limit value, a further signal is generated that in this case advantageously triggers a switch-off signal with which the monitored tool spindle or further machine functions are switched off.

Advantageously, when performing the method not only the temperature of the rotary bearing but also the environmental temperature of the monitored tool spindle is detected by means of at least one additional temperature sensor. This environmental temperature is then utilized for compensation of the temperature limit value of the rotary bearing and/or of the temperature value.

In a preferred embodiment, upon reaching the temperature limit value, a signal is sent to a smart device. Then appropriate measures can be carried out in order to monitor, for example, the causes of the temperature increase of the rotary bearing or to schedule and initiate preventive maintenance.

The subject matter of the application not only results from the subject matter of the individual claims but also from all specifications and features disclosed in the drawings and the description. They are claimed as being important to the invention, even if they are not subject matter of the claims, inasmuch as, individually or in combination, they are novel relative to the prior art.

Additional features of the invention result from the additional claims, the description, and the drawings.

### BRIEF DESCRIPTION OF THE DRAWINGS

The invention will be explained in more detail with the aid of an embodiment illustrated in the drawings.

FIG. 1 shows in schematic illustration a moulding machine with spindles in accordance with the invention.

FIG. 2 shows in perspective illustration a spindle.

FIG. 3 shows an axial section through the spindle of FIG. 2.

FIG. 4 shows a further axial section through the spindle according to FIG. 2.

FIG. 5 shows in a radial section the fastening region of two temperature sensors at the spindle.

FIG. 6 shows a block diagram of a temperature monitoring device in accordance with the invention.

### DESCRIPTION OF THE PREFERRED EMBODIMENTS

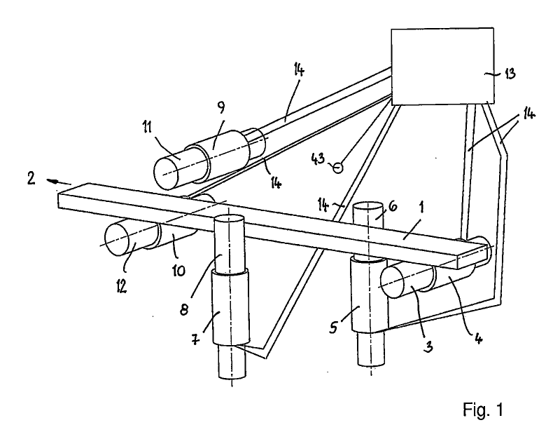

FIG. 1 shows in schematic illustration a moulding machine with which workpieces 1 of wood, plastic material and the like of rectangular cross section can be machined at all four sides in a through-feed method.

FIG. 1 shows only the spindles and the schematically shown tools seated thereon with which the workpiece machining is carried out. The transport elements, supports for the workpieces, and the like are not illustrated to simplify the drawing. The workpieces 1 are transported in the direction of arrow 2 through the moulding machine. First, the bottom side of the workpieces 1 is machined by a tool 3 which is seated on a horizontal spindle 4. With the tool 3, the workpiece 1 is planed, for example. In transport direction 2, downstream of the lower horizontal spindle 4, there is a vertical right spindle 5 which supports a tool 6 with which the right longitudinal side of the workpiece 1, in through-feed direction 2, is machined as the workpiece passes through the machine. In transport direction 2 downstream of the right vertical spindle, there is a left vertical spindle 7 on which a tool 8 is seated with which the left longitudinal side of the workpiece 1, in transport direction 2, is machined. In the through-feed direction 2 downstream of the left vertical spindle, an upper as well as a lower horizontal spindle 9, 10 are provided whose tools 11, 12 machine the top side and the bottom side of the workpiece 1. The tools can be respectively planing or profiling tools with which the respective sides are either planed or provided with a profile.

In all spindles 4, 5, 7, 9, 10, the bearings are monitored by temperature sensors whose signals are supplied to a control unit 13. These signals can be transmitted through conduits 14 but also wireless to the control unit 13 of the moulding machine.

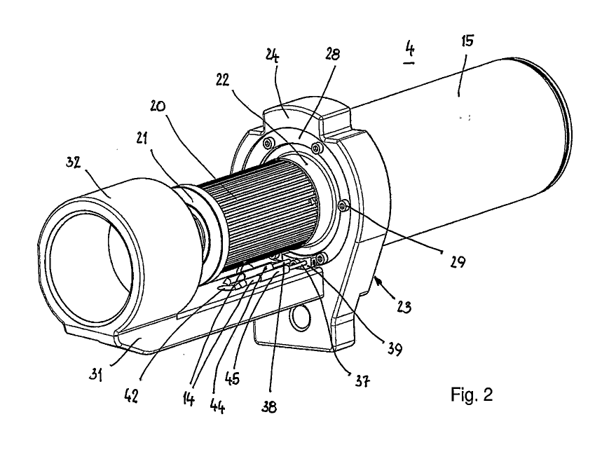

Based on FIGS. 2 through 5, the spindle 4 will be explained in more detail. The other spindles 5, 7, 9, 10 of the moulding machine have the same basic configuration.

The spindle 4 has a spindle housing 15 in which a spindle shaft 16 is rotatably supported. The spindle housing 15 is, for example, a cylindrical spindle sleeve which surrounds the spindle shaft 16 at a distance. At both ends of the spindle housing 15, there are rotary bearings 17, 18 for supporting the spindle shaft 16. The rotary bearings 17, 18 are advantageously roller bearings, in the embodiment ball bearings. Advantageously, two ball bearings adjacent to each other are provided at both ends of the spindle housing 15. The rotary bearings 17, 18 are axially secured in a suitable way in the spindle housing 15. The spindle 4 is received together with the spindle housing 15 in a bore of a spindle slide, not illustrated, and can be adjusted axially in this bore in a known way. This can be referred to as quill adjustment.

The spindle shaft 16 is provided at one end with a receptacle 19 which in the embodiment is a HSK receptacle that receives a tool. At the end axially projecting past the spindle housing 15, a drive disk 20 is provided which in the embodiment is a toothed belt disk across which an endless belt of a drive is guided with which the spindle shaft 16 is rotatably driven. The drive disk 20 is seated fixedly on the spindle shaft 16 and is secured axially between two rings 21, 22 fastened to the spindle shaft 16. The ring 21 is designed as a nut and serves together with the drive disk 20 and the ring 22 also for axial securing of the rotary bearing 17.

A holder 23 is fastened to the spindle 4. It has a receiving ring 24 which is provided at an end face with a recess 25 into which the spindle housing 15 projects with one end. The recess 25 is delimited axially by a radially inwardly oriented annular flange 26 against which the spindle housing 15 is resting with its end face rim.

The receiving ring 25 comprises at its other end face a further recess 27 that is significantly more flat than the recess 25 and is the result of a cutting machining of the cast holder 23. The bottom 28 (FIG. 2) machined in this way is penetrated by fastening screws 29 which are arranged in distribution about the circumference of the recess 27 and are screwed into threaded bores at the end face of the spindle housing 15.

The annular flange 26 as well as the neighboring region of the spindle housing 15 have approximately the same inner diameter. The ring 22 has a radially outwardly oriented annular flange 30 which, relative to the inner side of the annular flange 26 as well as relative to the inner side of the spindle housing 15, has only a minimal spacing and thus forms a sealing gap. In this way, penetration of chips or dust into the rotary bearings 17 is prevented.

A support arm 31 is projecting away from the receiving ring 24 and is provided at the free end with a holding ring 32 in which a release unit (not illustrated) for the tools 3 clamped in the spindle 4 is held. They are clamped in the HSK receptacle of the spindle 4 by known clamping means, not illustrated. The holder 23 serves not only for holding the release unit but also as a carrier of a nut or of a thread for the axial adjustment of the spindle.

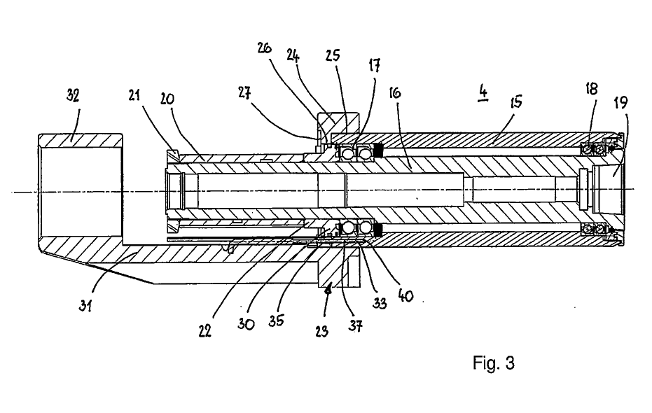

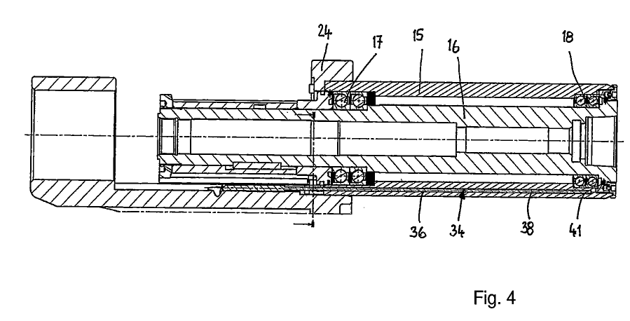

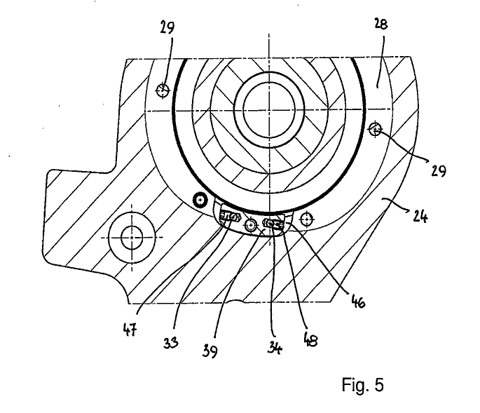

The spindle 4 is provided with temperature sensors 33, 34 with which the temperature of the rotary bearings 17, 18 can be detected. In the embodiment, the temperature sensors 33, 34 are guided through axial bores 35, 36 (FIGS. 3 and 4) in the spindle housing 15 to the respective bearings 17, 18. The sensors have a sensor head 40, 41, the actual temperature detector, which is introduced into the leading end of a thin tube 37, 38 in which sensor conduits (sensor wires) 14 are guided to the exterior. A sleeve 44, 45 (FIG. 2), advantageously a ferrule, adjoins the tube 37, 38 and from its end which is facing away from the tube 37, 38 the sheathed flexible sensor conduits 14 are exiting. The axial bores 35, 36 extend from the end face of the spindle housing 15 positioned in the receiving ring 24. The temperature sensors 33, 34 project with their tube 37, 38 through a fastening block 39 out of the spindle housing 15. The fastening block 39 is detachably fastened to the spindle housing 15. The annular flange 26 of the receiving ring 24 is interrupted by a cutout 46 in the region of the fastening block 39 (FIG. 5). The rims of the cutout 46 have each a spacing from the fastening block 39. In the fastening block 39, the tubes 37, 38 and thus also the temperature sensors 33, 34 are secured so that they cannot be displaced in the bores 35, 36. In this way, it is ensured that the sensor head 40, 41 is always at the level of the rotary bearing 17, 18 to be monitored. Securing, as in the embodiment, can be realized by means of threaded pins 47, 48 laterally screwed into the fastening block 39. In this way, length tolerances but also bores 35, 36 of different depth can be compensated. It is also possible to provide the sensors 33, 34 with a thread and screw them into the fastening block 39.

The sensor conduits 14 are guided in a suitable way to the machine control unit 13, as has been described and discussed in an exemplary fashion with the aid of FIG. 1 in regard to the conduits 14. In the illustrated embodiment, the sensor conduits 14 are extended through openings 42 in the support arm 31.

The temperature sensors 33, 34 can also be radially guided, in deviation from the illustrated embodiment, to the rotary bearings 17, 18 to be monitored. In this case, only very short bores for the temperature sensors 33, 34 are required.

With the temperature sensors 33, 34, the temperature of the rotary bearing 17, 18 can be monitored permanently. The signals of the temperature sensors 33, 34 are supplied to an evaluation unit. In the simplest case, upon surpassing a predetermined temperature limit value a signal is generated by the evaluation unit. It can be used in order to send a warning message to the user of the spindle or of the moulding machine. Also, it is possible to employ this signal in order to switch off corresponding machine function, for example, the rotary drive of the spindle 4 or the feed, i.e., the workpiece transport through the moulding machine. This limit value for the temperature of the rotary bearing 17, 18 can be adjusted to be so low that the correspondingly evaluated signal of the temperature sensors 33, 34 is sent out in due time when the rotary bearings 17, 18 are not yet damaged. The temperature sensors 33, 34 serve in this case for preventive maintenance as well as early detection of bearing damage. In this way, it is reliably prevented that, due to bearing damage that has not been detected early enough, secondary damages at the spindle or at the moulding machine will occur.

It is advantageous when not only one limit value but, for example, also two or several limit values are provided. In this way, upon surpassing the first limit temperature a first warning can be generated that notifies the user that possibly greater bearing damages may occur with continued operation of the spindle. Upon reaching a second higher limit temperature, the control unit 13 can be configured such that it then switches off the spindles 4, 5, 7, 9, 10 as well as the feed in order to prevent secondary damage.

By use of the temperature sensors 33, 34 it is thus possible to provide a preventive maintenance and therefore a reduction of unplanned downtime which would occur when a temperature monitoring of the rotary bearings is not performed. Because damages at the rotary bearings 17, 18 can be detected early on by use of the temperature sensors 33, 34, secondary damages at the spindle 4 as well as also at surrounding parts within the machine can be prevented. In this way, repair costs are reduced also.

In the illustrated and described embodiment, the sensor signals are transmitted through sensor conduits 14 to the machine control unit 13. However, temperature sensors can be used also that transmit their signals wireless. In this case, the sensors can be installed in particular directly at or in the rotary bearings 17, 18 so that the temperature of the rotary bearings 17, 18 can be detected even more precisely. The temperature sensors 33, 34 can transmit their signals, for example, by radio, for example, to receiving units which are arranged in the region of the individual spindles. The receiving units for the wireless transmission of the sensor signals are, in turn, connected by conduits 14 with the control unit 13. Such sensors facilitate installation in the spindle 4 because no measures are required anymore for passing through the sensor conduits.

Even when the temperature sensors 33, 34 transmit their signals by means of sensor conduits 14, the sensors can be directly arranged in the rotary bearing 17, 18.

The reliability of the bearing diagnosis or of the detection of a bearing damage can be improved in an advantageous way in that also the environmental temperature of the spindle 4 is measured. For this purpose, as schematically indicated in FIG. 1, at least one additional temperature sensor 43 is provided which is connected to the machine control unit or the evaluation unit 13. This sensor 43 can also transmit its signals by sensor conduits or wireless, for example, by radio. By detecting the environmental temperature of the spindle 4, the effect of the environmental temperature on the temperature of the rotary bearings 17, 18 can be taken into account in the evaluation and compensated.

Since the inner chamber temperature of the machine which is detected by the at least one additional temperature sensor 33 has an effect on the temperature of the rotary bearings 17, 18, the control unit 13 can be embodied such that the limit values of the bearing temperatures or the detected bearing temperature values themselves automatically are adjusted to the measured inner chamber temperature. For example, when the inner chamber temperature of the machine measured by the temperature sensor 43 rises, the temperature of the rotary bearings 17, 18 also rises. This temperature rise however is then not caused by a corresponding load on the rotary bearings. Accordingly, the control unit or the evaluation of the temperature sensors is configured such that the corresponding limit values are raised such that the effect of the inner temperature of the machine on the temperature of the rotary bearings 17, 18 is compensated.

Moreover, the control unit 13 or the evaluation unit can be configured such that it does not automatically compensate and adjust the temperature limit values of the rotary bearings 17, 18 but instead the spindle temperature values as a function of the inner temperature of the machine in that, for example, an inner temperature dependent corrective value is subtracted from the measured temperature value or added to it. A combination of both methods is also possible.

The automatic adaptation and compensation has the advantage that the user of the machine must not carry out the adjustment himself.

However, it is absolutely possible to configure the control unit 13 such that the limit values for the bearing temperatures are manually adjusted as a function of the measured inner chamber temperature of the machine.

The temperature monitoring of the rotary bearings 17, 18 can be configured such that the temperature values are stored continuously. In this way, it is possible to record the history of the temperature course of the individual temperature sensors 33, 34 and, for example, check the frequency of surpassing the limit values over a certain period of time. These stored data can be stored, for example, in the evaluation unit, the machine control unit or by transmission to a cloud so that authorized persons at any time can retrieve the stored measured values and evaluate them. This is in particular advantageous in connection with servicing. In particular, the storage in a cloud provides the possibility of advantageous utilization of so-called smart devices and apps for analysis and display of certain data from machine-independent locations.

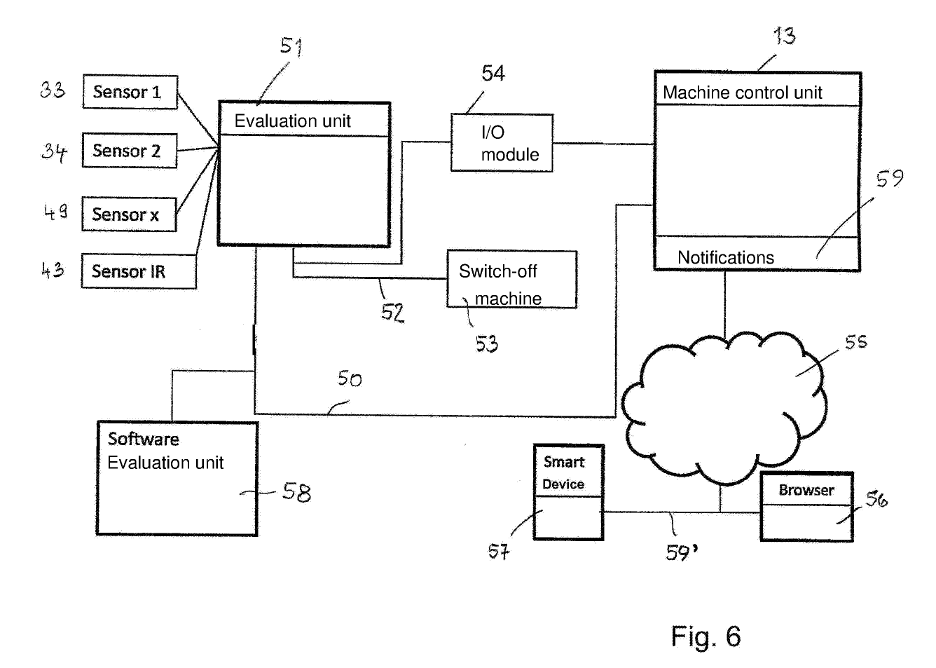

FIG. 6 shows in schematic illustration an exemplary system of the temperature monitoring of the spindle. This temperature monitoring system has the evaluation unit 51, to which the signals of the temperature sensors 33, 34, 43 are supplied. More sensors than illustrated in FIG. 6 can be connected to the evaluation unit 51. In FIG. 6, for example, an additional sensor 49 is indicated. The evaluation unit 51 converts the sensor signals to temperature values. The sensors 33, 34, 43, 49 can transmit the signals wireless or wire-bound to the evaluation unit 51.

The evaluation unit 51 is connected through a conduit 50, for example, of a network or data network, to the machine control unit 13 which therethrough can retrieve the temperature values of the sensors 33, 34, 43, 49 at any time.

The conduit 50 can also be understood such that it is a radio pathway by means of which the temperature values are supplied wireless to the machine control unit 13. For the conduits to be explained in the following it is also true that a wire-bound as well as a wireless transmission can be carried out with them.

The evaluation unit 51 can send through a conduit 52 in the described way a switch-off signal in case a temperature value measured by the sensors surpasses the critical temperature value of the respective spindle. In this case, the woodworking machine 53 is switched off so that damage to the respective spindle or even to the entire machine is reliably prevented.

The machine control unit 13 is advantageously configured such that at certain time intervals, for example, every 5 minutes, the temperature is transferred to a cloud 55. Advantageously, at the same time also status data of the machine are transferred. The transferred values are stored as a data set in a database in the cloud 55. For this purpose, the actual temperature values of the individual temperature sensors 33, 34, 43, 49 are retrieved through the conduit 50 from the evaluation unit 51.

Advantageously, these data are also written to a text file of the machine control unit 13. Such a text file is produced, for example, every day and stored in the machine control unit. The status data of the machine 53 are also included in this text file produced daily.

The data and values stored in the cloud 55 can be retrieved by authorized persons at any time with the aid of a browser 56 or a smart device 57 by means of an app installed thereon.

Cloud 55 is to be understood as an external decentralized server (network server, cloud server) which can be accessed from different locations and on which an application software is implemented, referred to as a so-called service, which handles and administers the transmitted data. The transmitted data not only may be the data of the temperature monitoring but also other machine data and data of different machines. For example, the data are stored in a database and, for retrieval by means of the browser 56 or the smart device 57, are processed and represented in a corresponding form depending on preset authorizations. Advantageously, the application software of the cloud also makes available possibilities for evaluating the data.

In this way, there is the possibility that a service technician of the manufacturer of the machine can check the stored data/values and can provide information to the operator of the machine as to how he can avoid exceeding the temperatures at the machine. The service technician can also check based on the stored data whether an exchange of machine parts is necessary in order to avoid future temperature exceedance events.

Data of the control software for the machine control unit 13 can be stored also in the cloud 55. Then it is possible via the browser 56 or the smart device 57 to upload data for an update of the software into the cloud 55 so that the operator of the machine can perform the update of the control software.

Furthermore, there is the possibility to store in the cloud 55 client-specific data, machine-specific data and the like which can be retrieved by the operator of the machine 53 and/or by the service technician.

A software 58 is provided for the parametrization of the evaluation unit 51. The software 58 is in general used only for the adjustment of the evaluation unit 51 or for changing inputs in the evaluation unit. Also, the software 58, aside from programming of the evaluation unit 51, can be used for storing the detected temperature values.

The control unit 13 can be connected to a monitor or screen (not illustrated), on which, for example, warning messages 59 can be displayed. Thus, a warning message 59 can be shown when, for example, when using two temperature values, the first limit value of the temperature is reached. When reaching the second limit value by one of the temperature sensors 33, 34, 43, 49, a corresponding informative message can be displayed that the spindles and the feed have been shut off because of exceedance of this limit value.

These warning or informative messages are initiated by corresponding output signals of the evaluation unit 51 whose connection to the machine control unit 13 is realized advantageously via an I/O module 54.

When a warning message 59 occurs, a current data set is generated and transferred to the cloud 55 based on which, in turn, the latter recognizes exceedance of the limit value. In this context, the software can be configured such that, in turn, a warning message 59′ is directly displayed on the smart device 57. In this context, it is possible to transmit this warning message 59′ in a targeted fashion only to certain authorized persons. This can be done, for example, by e-mail or by an SMS. In order for the warning message 59′ to be supplied instantly to the smart device 57, it is advantageous when the warning message 59′ is transmitted as a push message. The user of the smart device 57 can himself determine by using the app whether or in which form he wants to receive a warning message 59′.

In addition to the predetermined transmission of the data to the cloud and to the text file based on the time interval, the transmission of a data set is thus always carried out instantly when a limit value of the temperature values has been surpassed, i.e., event-controlled. The trigger for this is provided to the machine control unit 13, as described, by means of the output signal of the evaluation unit 51. There is no waiting for the machine control unit 13 to start the next query cycle.

In an advantageous embodiment, the data sets are supplemented by the temperature limit values of the respective spindle. The temperature limit values are advantageously transmitted to the cloud only every time the woodworking machine is switched on and are adopted by all other data sets. Therefore, each data set transmitted to the cloud can be checked in regard to whether a limit value exceedance exits for a temperature value. Should this be the case, this data set is written into a so-called log file and sending of the warning message 59′ is triggered.

However, it is also possible that the data set which, as a result of the temperature limit value exceedance, has been transmitted to the cloud, is detected as such by the cloud, for example, because it contains a certain identification. In this case, an evaluation of the temperature values with regard to their limit values is not needed. The data set is immediately written into the log file and sending of the warning message 59′ is triggered.

The warning message 59′ is supplied to the smart device 57 independent of where the authorized person with his smart device 57 is located. In this way, it is ensured that, for example, a service technician can react immediately to a warning message 59′.

The temperature monitoring system enables the authorized person to produce a remote diagnosis by retrieving and analyzing the data/values stored in the cloud 55 by means of the smart device 57 or the browser 56. Since the temperature courses of the individual sensors 33, 34, 43, 49 over time are stored in the cloud 55 together with the machine status data at the respective points in time, the authorized person can generally recognize based on the data which error has occurred or which cause led to exceeding the temperature limit values and can provide corresponding instructions. Advantageously, the diagnosis can be realized by means of the application software which is present in the cloud 55 or it supports the user in this context by already processed and evaluated data.

This service app is advantageously configured such that all relevant data of the machine 53 or its machine parts, in particular of the spindles, are displayed by it. It is also possible in this context to display the machine 53 with the machine part to be monitored on the screen of the smart device 57, which facilitates the error diagnosis for the service technician.

Furthermore, it is possible in an exemplary fashion to display on the screen of the smart device 57, for example, the workpiece profile to be generated or, for example, the employed tool.

Since all these values and data are transferred from the machine control unit 13 to the cloud 55, these data and values are available to the persons with authorized access to the cloud 55 at any time.

The access to the cloud 55 is possible in a simple way through the browser 56 and/or the smart device 57 such as a smart phone.

Since the rotary bearings 17, 18 are monitored separately, their status can be precisely monitored independent of each other.

When recording the measured data in a storage device, different values can be additionally protocolled. A timestamp is recorded which indicates at which point in time the protocolled monitoring and storage of the entire data set has taken place. Not only the temperature values of the rotary bearings 17, 18 but also the environmental temperature of the monitored spindle, i.e., the inner chamber temperature in the machine, can be recorded. Moreover, it is possible to store status data of the machine, for example, whether at the point in time of protocolling the monitored spindles are switched on or off, at which rotary speeds they are running, whether the feed is switched on or off, whether workpieces 1 to be machined are present in the machine, which profile is to be generated at the workpieces, which tools are employed, and the like. Based on the history of these stored values, it is also possible, for example, to detect when and how long the spindles or the feed had been switched on or off. The signals of the temperature sensors 33, 34, as described, are supplied to one or a plurality of evaluation units 51 monitoring them with respect to the predetermined limit values. The evaluation units 51 can be a component of the machine control unit 13 or can be provided as a unit or units independent therefrom. In the first case, the machine control unit 13 itself recognizes exceedance of a limit value and transmits, as described, the current data set to the cloud or to the text file. In the latter case, the evaluation unit can switch off directly the described machine functions and the machine control unit can send a signal for displaying a warning or error message.

It is advantageous when the respective current temperatures are retrievable directly onto the screen of the machine control unit and those temperatures, which have surpassed the adjusted limit values, are marked, for example, are highlighted by color, are written in color, are blinking or something like this. It is also advantageous when the operator receives through the machine control unit a message indicating due to which limit value exceedance at which bearing of which spindle the machine (spindles and feed) has been switched off.

What is claimed is:

1. Temperature monitoring device for tool spindles of woodworking machines, preferably moulding machines, with a spindle housing in which a spindle shaft with at least one rotary bearing is supported, and with at least one temperature sensor (33, 34, 43, 49) provided for detecting the temperature of the rotary bearing (17, 18), whose signals are supplied to at least one evaluation unit (13) which converts the signals to temperature values,
characterized in that the temperature values are stored in at least one cloud (55) from where the data by means of an app located on a smart device (57) and/or by means of a browser (56) can be retrieved.

2. Temperature monitoring device according to claim 1, characterized in that the temperature limit values and/or status data of the woodworking machine (53) can be stored in the cloud (55).

3. Temperature monitoring device according to claim 1,
characterized in that the evaluation unit (51) and a control unit (13) for the machine (53) containing the tool spindle (4) are connected by a common network.

4. Temperature monitoring device according to claim 1,
characterized in that the control unit (13) transmits data sets to the cloud (55).

5. Temperature monitoring device according to claim 1,
characterized in that the control unit (13) transmits data sets to the cloud (55) in predetermined time intervals or upon occurrence of exceedance of a temperature limit value.

6. Temperature monitoring device according to claim 1,
characterized in that messages (59′) from the cloud (55) are sent by push service to the smart device (57).

7. Temperature monitoring device according to claim 1,
characterized in that the messages (59′) are sent by e-mail or as SMS to the smart device (57).

8. Temperature monitoring device according to claim 1,
characterized in that the data and/or messages (59′) can be sent only to users of the app lodged as authorized persons or retrieved by these users.

9. Temperature monitoring device according to claim 1,
characterized in that the temperature sensor (33, 34) is arranged adjacent to the rotary bearing (17, 18) in the spindle housing (15).

10. Temperature monitoring device according to claim 1,
characterized in that the spindle housing (15) comprises at least one axial bore (35, 36) or at least one approximately radially extending bore which opens at an end face of the spindle housing (15) or at the outer side of the spindle housing (15) and receives the temperature sensor (33, 34).

11. Temperature monitoring device according to claim 1,
characterized in that the temperature sensor (33, 34) is arranged directly at or in the rotary bearing (17, 18).

12. Temperature monitoring device according to claim 1,
characterized in that the machine (53) is a moulding machine.

13. Woodworking machine, in particular moulding machine, with tool spindles for machining workpieces of wood, plastic material and the like, with a temperature monitoring device according to claim 1.

14. Woodworking machine according to claim 13,
characterized in that in the woodworking machine at least one additional temperature sensor (43) is arranged which detects the inner temperature of the woodworking machine.

15. Woodworking machine according to claim 13,
characterized in that the signals of the additional temperature sensor (43) are used for compensation of the limit value of the rotary bearing temperature and/or of the temperature value of the spindle (4).

16. Method for monitoring the temperature of at least one rotary bearing of a tool spindle of a woodworking machine, in which with at least one temperature sensor (33, 34, 43, 49) the temperature of the rotary bearing (17, 18) is permanently detected and supplied to at least one evaluation unit (13, 51) which compares the supplied temperature signals with at least one temperature limit value and generates a signal when the supplied temperature signals have reached the temperature limit value, wherein the data gathered by the evaluation unit (13, 51) are stored in a cloud (55) and the data are retrievable in processed form by means of an app located on a smart device (57) and/or by means of a browser (56).

17. Method according to claim 16,
characterized in that the data are processed for retrieval in the cloud (55).

18. Method according to claim 16,
characterized in that the signal generated by the evaluation unit (13, 51) triggers a warning signal or a switch-off signal by means of which machine functions such as spindles, feed are switched off.

19. Method according to claims 16,
characterized in that the environmental temperature of the monitored tool spindle (4) is detected by at least one additional temperature sensor (43) and is used for compensation of the at least one temperature limit value and/or of the temperature value of the spindle (4).

20. Method according to claim 16,
characterized in that a message (59′) is sent to a smart device (57) when the temperature limit value is reached.
